(19) United States
(12) Patent Application Publication
(10) Pub. No.: US 2008/0268777 A1
(43) Pub. Date: Oct. 30, 2008

(54) Apparatus for combining bluetooth headset and speaker base

(76) Inventor: Pi-Fen Lin, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/790,705

(22) Filed: Apr. 27, 2007

(51) Int. Cl. H04B 7/00

(52) U.S. Cl. 455/41.2

(57) ABSTRACT

An apparatus for combining a Bluetooth headset and a speaker base is disclosed. The principle of magnetic adsorptive is used to combine the Bluetooth headset with the speaker base. The apparatus for combining a Bluetooth headset and a speaker base includes a Bluetooth headset and a speaker base. The Bluetooth headset has an absorbable part and a signal-transmitting terminal. The speaker base has a headset receiving slot and a control circuit board. The headset receiving slot has a magnetic element. When the Bluetooth headset approaches the headset receiving slot, the magnetic element absorbs the absorbable part of the Bluetooth headset to receive the Bluetooth headset in the headset receiving slot and electrically connect the signal-transmitting terminal of the Bluetooth headset with the control circuit board of the speaker base.

### BACKGROUND OF THE INVENTION

1. Field of the Invention

The present invention relates to an apparatus for combining a Bluetooth headset and a speaker base. In particular, this invention relates to an apparatus for combining a Bluetooth headset and a speaker base by utilizing the principle of magnetic adsorptive.

2. Description of the Related Art

Bluetooth is a low cost, low power, and short distance wireless communication technology that can be applied to personal mobile communication devices. Bluetooth technology uses wireless transmitting for Bluetooth headsets, portable cell phone watches, and communicators that can be worn on a finger. When these devices are built in with a Bluetooth chip, they can transmit signals wirelessly. Furthermore, these devices also have Internet and e-mail functions. They are convenient for the user.

In the marketplace, there are a great number of Bluetooth headsets that cooperate with a Bluetooth cell phone. The user wears the Bluetooth headset on his head and can communicate in two-directions with the Bluetooth cell phone at a standard frequency period. No matter the time or the place, the user can use their cell phone by utilizing wireless transmission of Bluetooth technology, without holding their cell phone.

Reference is made to FIG. 1, which is a schematic diagram of communication between a Bluetooth headset and a Bluetooth cell phone of the prior art. Bluetooth communication technology is used to transmit voice information 50 from the Bluetooth cell phone 60 to the Bluetooth headset 40 wirelessly. It also transmits voice information 52 to a Bluetooth cell phone 60 via the Bluetooth headset 40 by Bluetooth communication technology. Thereby, a voice can be transmitted in two-directions. Therefore, the user can receive an incoming call at any location, without holding their cell phone.

Reference is made to FIGS. 1 and 2. FIG. 2 shows a block diagram of the circuit of a Bluetooth cell phone of the prior art. When an incoming call is received, the wireless communication unit 401 of the Bluetooth headset 40 receives the incoming call voice information 50 from the remote Bluetooth headset 60. The incoming call voice information 50 is transmitted to a controller 402 and is processed. After the incoming call voice information 50 is processed by the controller 402, the incoming call voice information 50 is sent out from the headset 404 so that the user hears the voice clearly.

At the same time, the user also transmits the answering voice information 52 to the controller 402 via the microphone 403. After the answering voice information 52 is processed by the controller 402, the answering voice information 52 is transmitted to the wireless communication unit 401. Next, the answering voice information 52 is transmitted to the remote Bluetooth cell phone 60. Therefore, the voice is transmitted in two-directions. The user can receive and answer the incoming call at any location, without holding the cell phone.

However, when the call is incoming, the Bluetooth headset merely allows one user to receive and answer the incoming call. Third parties cannot participate in the call. It is inconvenient.

### SUMMARY OF THE INVENTION

One particular aspect of the present invention is to provide an apparatus for combining a Bluetooth headset and a speaker base. It uses the principle of magnetic adsorptive to rapidly combine and position the Bluetooth headset with the speaker base.

The apparatus for combining a Bluetooth headset and a speaker base includes a Bluetooth headset and a speaker base. The Bluetooth headset has an absorbable part and a signal-transmitting terminal. The speaker base has a headset receiving slot and a control circuit board. On both sides of the headset receiving slot there is a magnetic element. Thereby, when the Bluetooth headset approaches the headset receiving slot, the magnetic element absorbs the absorbable part of the Bluetooth headset to receive the Bluetooth headset in the headset receiving slot and electrically connect the signal-transmitting terminal of the Bluetooth headset with the control circuit board of the speaker base.

The control circuit board includes a controller, an amplifier, and a microphone. The controller is electrically connected with the signal-transmitting terminal of the Bluetooth headset. The amplifier is electrically connected with the controller. The microphone is electrically connected with the controller. Thereby, when an incoming call is received, the controller obtains an incoming call signal from the Bluetooth headset, and sends the incoming call signal to the amplifier and the microphone to transmit the voice in two-directions.

The present invention uses the amplifier to amplify the incoming call signal received from the remote cell phone by the Bluetooth headset so that a plurality of people can hear the voice clearly. At the same time, the present invention uses the microphone to transmit the answering voice signal from all people to the Bluetooth headset. Next, the answering voice signal is transmitted to the remote cell phone via the Bluetooth headset. Therefore, the voice is transmitted in two-directions. Furthermore, the user can use the present invention to communicate with three or more persons at the same time.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the communication between the Bluetooth headset and the Bluetooth cell phone of the prior art;

FIG. 2 is a block diagram of the circuit of the Bluetooth cell phone of the prior art;

FIG. 3 is a schematic diagram of the appearance of the present invention;

FIG. 4 is a block diagram of the circuit of the present invention; and

FIG. 5 is a schematic diagram of the circuit of the speaker base of the present invention.

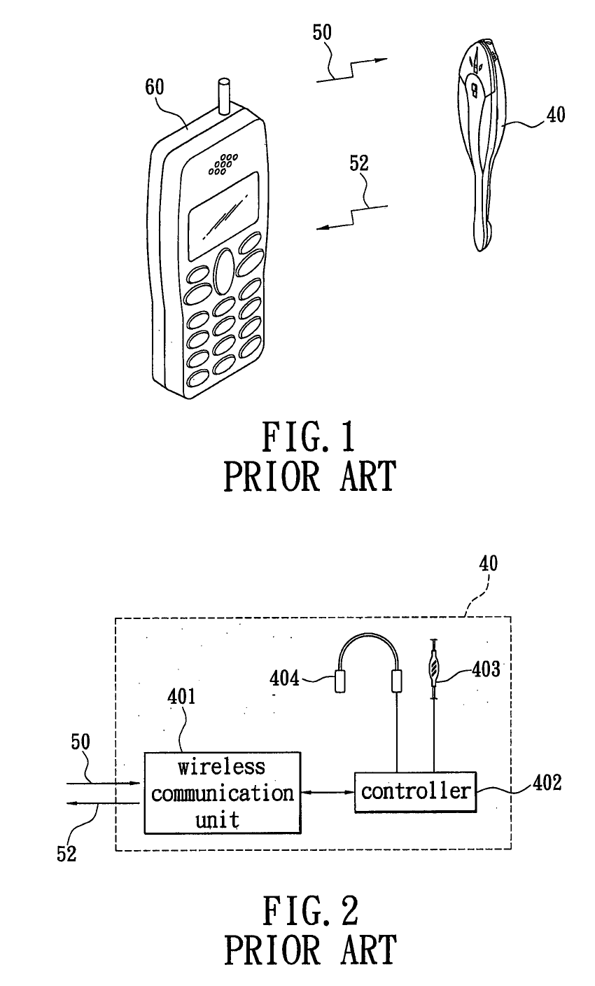

### DETAILED DESCRIPTION OF THE PREFERRED EMBODIMENTS

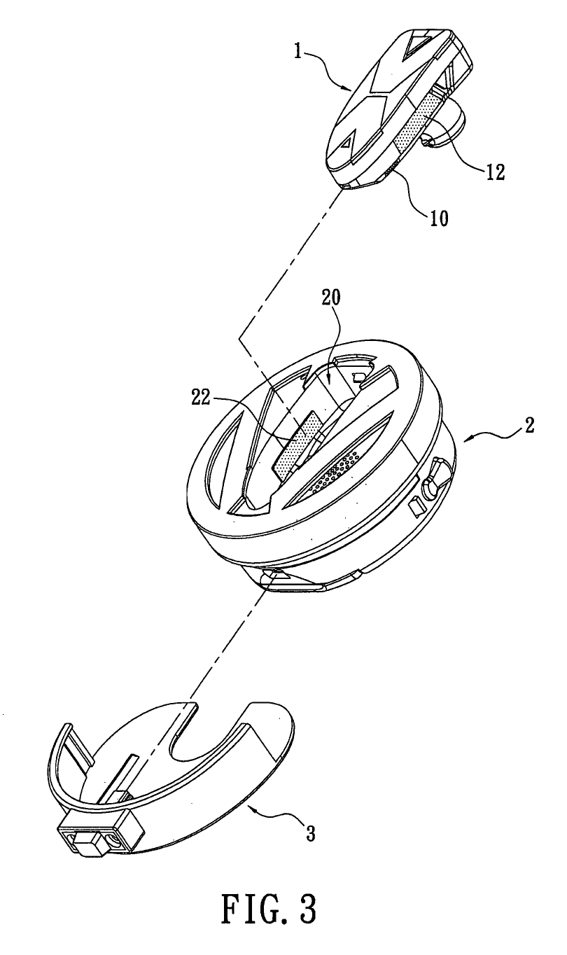

Reference is made to FIG. 3, which shows a schematic diagram of the appearance of the present invention. The apparatus for combining a Bluetooth headset and a speaker base includes a Bluetooth headset 1 and a speaker base 2. The Bluetooth headset 1 has an absorbable part 12 and a signal-transmitting terminal 10. The speaker base 2 has a headset receiving slot 20 and a control circuit board (not labeled). On both sides of the headset receiving slot 20, there is a magnetic element.

When the Bluetooth headset 1 approaches the headset receiving slot 20, the magnetic elements 22 located on both sides of the headset receiving slot 20 of the speaker base 2 absorb the absorbable part 12 of the Bluetooth headset 1 so that the Bluetooth headset 1 is rapidly received and positioned in the headset receiving slot 20. After the Bluetooth headset 1 is combined with the speaker base 2, the signal-transmitting terminal 10 of the Bluetooth headset 1 is electrically connected with the controller 21 located on the control circuit board of the speaker base 2.

Reference is made to FIG. 3 again. The control circuit board of the speaker base 2 is electrically connected with an electronic car appliance (not shown in the figure) via a car signal connector 3. The electronic car appliance can be a car audio player or/and an electronic car power-generating device.

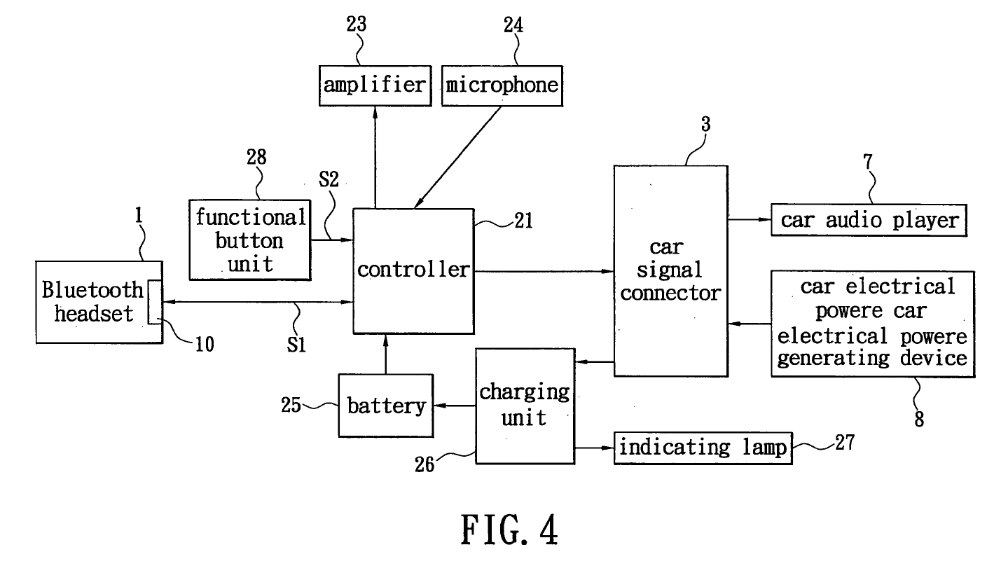

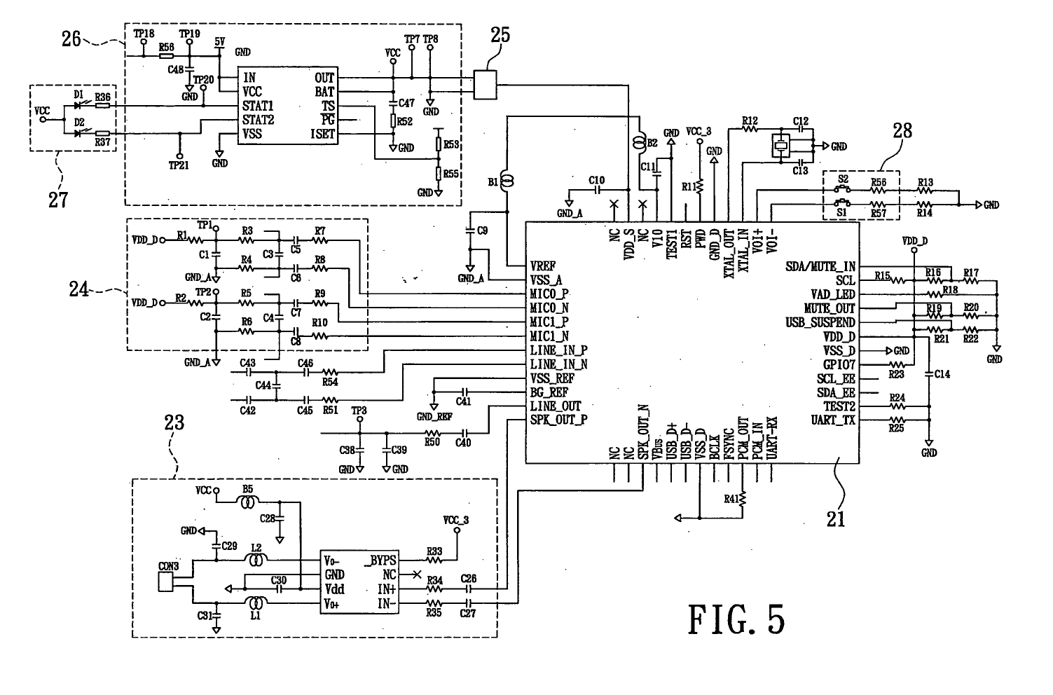

Reference is made to FIG. 4, which shows a block diagram of the circuit of the present invention. The apparatus for combining a Bluetooth headset and a speaker base includes a Bluetooth headset 1 and a speaker base 2. Reference is also made to FIG. 5, which shows a schematic diagram of the circuit of the speaker base of the present invention. The control circuit board of the speaker base 2 includes a controller 21, an amplifier 23, and a microphone 24. The controller 21 is an FM1182 integrated circuit. The amplifier 23 is composed of an EUA6204MIR1 integrated circuit, inductors L1, L2, and other electronic components. The microphone 24 is composed of resistors R1, R2, and capacitors C1˜C8. The controller 21 is electrically connected with the signal-transmitting terminal 10 of the Bluetooth headset 1. The controller 21 transmits data and processes data with the Bluetooth headset 1 via the signal-transmitting terminal 10. The amplifier 23 is electrically connected with the controller 21, and is controlled by the controller 21 for amplifying the voice signals. The microphone 24 is electrically connected with the controller 21, and is controlled by the controller 21 for obtaining voices.

Reference is made to FIG. 4 again. When a call from a remote cell phone (not shown in the figure) is received, the controller 21 obtains an incoming call signal S1 from the Bluetooth headset 1, and sends the incoming call signal S1 to the amplifier 23 and the microphone 24 to transmit the voice in two-directions, and amplify the voice.

When the Bluetooth headset 1 is received in the speaker base 2, the speaker base 2 amplifies the voice for the Bluetooth headset 1. The controller 21 of the speaker base 2 has an echo-eliminating function. The operation principal is illustrated as below. When an incoming call is received, the receiving-key of the Bluetooth headset 1 is pressed to build a voice channel. The incoming call signal S1 is transmitted to the controller 21 of the speaker base 2 via the Bluetooth headset 1, and is processed. The controller 21 uses an analog-to-digital converter located in the controller 21 to convert the incoming call signal S1 into a first digital signal and record it. Next, the first digital signal is processed by a digital-to-analog converter, and the incoming call voice signal is amplified by the amplifier 23 so that the receiving user can hear the caller's voice.

Because the speaker base 2 has an amplifying function, the voice signal outputted from the amplifier 23 is loud. When the microphone 24 receives the voice signal, an echo signal is generated. The controller 21 uses the interior analog-to-digital converter to convert the echo signal into a second digital signal, and compares the second digital signal with the first digital signal. If the second digital signal matches the first digital signal, the controller 21 restrains the second digital signal to eliminate the echo signal. Reference is made to FIGS. 4 and 5. The speaker base 21 further includes a functional button unit 28. The functional button unit 28 is composed of resistors R1, R2 and switches S1, S2. The functional button unit 28 is connected with the controller 21, and transmits a control instruction S2 to the controller 21 for adjusting the volume.

Furthermore, the controller 21 can be electrically with the car audio player 7, and the electronic car power-generating device 8 via the car signal connector 3. When the present invention is connected with the car audio player 7, the controller 21 controls the incoming call signal S1 to switch to the car audio player 7. Therefore, the car audio player 7 transmits the voice signal in two-directions and amplifies the voice signal.

Reference is made to FIGS. 4 and 5 again. The control circuit board further includes a charging unit 26, a battery 25, and an indicating lamp 27. The charging unit 26 is composed of a BQ24010DRC integrated circuit, capacitors C47, C48, and resistors R52, R53, R55, R56. The indicating lamp 27 is composed of resistors R36, R37 and lighting elements D1, D2. The battery 25 is connected with the controller 21 for providing power to the controller 21. The charging unit 26 is connected with the battery 25 and the indicating lamp 27. When the present invention is connected with the electronic car power-generating device 8, the charging unit 26 receives electric power from the electronic car power-generating device 8 via the car signal connector 3 to charge the battery 25 located on the control circuit board.

Reference is made to FIG. 4 again. The Bluetooth headset 1 receives the incoming call signal S1 and transmits the incoming call signal S1 to the controller 21 of the speaker base 2 via the signal-transmitting terminal 10. The controller 21 process the incoming call signal S1, and switches the voice transmission path according to the control instruction S2 outputted from the functional button unit 28. Based on the control instruction S2, the controller 21 switches the voice transmission path to the amplifier 23 and the microphone 24 so that the amplifier 23 and the microphone 24 can transmit the voice signal in two-directions and amplify the voice signal. Alternatively, the controller 21 switches the voice transmission path to the car audio player 7 so that the car audio player 7 can transmit the voice signal in two-directions and amplify the voice signal.

The apparatus for combining a Bluetooth headset and a speaker base of the present invention utilizes the principle of magnetic adsorptive to rapidly combine and position the Bluetooth headset with the speaker base. When the Bluetooth headset 1 approaches the speaker base 2, the magnetic elements 22 located on both sides of the headset receiving slot 20 of the speaker base 2 absorb the absorbable part 12 of the Bluetooth headset 1 so that the Bluetooth headset 1 is rapidly received and positioned in the headset receiving slot 20.

Furthermore, after the Bluetooth headset 1 is combined with the speaker base 2, the signal-transmitting terminal 10 of the Bluetooth headset 1 is electrically connected with the controller 21 located on the control circuit board of the speaker base 2. At this time, the Bluetooth headset 1 receives the incoming call signal S1 and transmits the incoming call signal S1 to the controller 21 of the speaker base 2 via the signal-transmitting terminal 10. The controller 21 processes the incoming call signal S1, and switches the voice transmission path according to the control instruction S2 outputted from the functional button unit 28. Based on the control instruction S2, the controller 21 can switch the voice transmission path to the amplifier 23 and the microphone 24 so that the amplifier 23 and the microphone 24 can transmit the voice signal in two-directions and amplify the voice signal. Alternatively, the controller 21 switches the voice transmission path to the car audio player 7 so that the car audio player 7 can transmit the voice signal in two-directions and amplify the voice signal.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An apparatus for combining a Bluetooth headset and a speaker base, comprising:
a Bluetooth headset having an absorbable part and a signal-transmitting terminal; and
a speaker base having a headset receiving slot and a control circuit board, wherein the headset receiving slot has a magnetic element;
wherein when the Bluetooth headset approaches the headset receiving slot, the magnetic element absorbs the absorbable part of the Bluetooth headset to receive the Bluetooth headset in the headset receiving slot and electrically connect the signal-transmitting terminal of the Bluetooth headset with the control circuit board of the speaker base.

2. The apparatus for combining a Bluetooth headset and a speaker base as claimed in claim 1, wherein the control circuit board comprises:
a controller electrically connected with the signal-transmitting terminal of the Bluetooth headset;
an amplifier electrically connected with the controller; and
a microphone electrically connected with the controller;
thereby, when an incoming call is received, the controller obtains an incoming call signal from the Bluetooth headset, and sends the incoming call signal to the amplifier and the microphone to transmit the voice signal in two-directions.

3. The apparatus for combining a Bluetooth headset and a speaker base as claimed in claim 2, wherein the control circuit board is electrically connected with an electronic car appliance via a car signal connector.

4. The apparatus for combining a Bluetooth headset and a speaker base as claimed in claim 3, wherein the electronic car appliance is a car audio player, and the controller switches the incoming call signal to the car audio player for transmitting the voice signal in two-directions when an incoming call is received.

5. The apparatus for combining a Bluetooth headset and a speaker base as claimed in claim 3, wherein the electronic car appliance is an electronic car power-generating device.

6. The apparatus for combining a Bluetooth headset and a speaker base as claimed in claim 5, wherein the control circuit board further includes a charging unit, and the charging unit is connected with the electronic car power-generating device to charge a battery located on the control circuit board.

7. The apparatus for combining a Bluetooth headset and a speaker base as claimed in claim 6, wherein the control circuit board further includes an indicating lamp, and the indicating lamp is connected with the charging unit for indicating the charging status.

8. The apparatus for combining a Bluetooth headset and a speaker base as claimed in claim 2, further comprising a functional button unit, wherein the functional button unit is connected with the controller for providing a control instruction to the controller.

9. The apparatus for combining a Bluetooth headset and a speaker base as claimed in claim 2, wherein the controller eliminates echo signals generated when the amplifier and the microphone is operating.

10. An apparatus for combining a Bluetooth headset and a speaker base, comprising:
a Bluetooth headset having an absorbable part and a signal-transmitting terminal; and
a speaker base having a headset receiving slot and a control circuit board, wherein on both sides of the headset receiving slot, there is a magnetic element, and the control circuit board includes a controller, an amplifier electrically connected with the controller, and a microphone electrically connected with the controller;
wherein when the Bluetooth headset approaches the headset receiving slot, the magnetic element absorbs the absorbable part of the Bluetooth headset to receive the Bluetooth headset in the headset receiving slot and electrically connect the signal-transmitting terminal of the Bluetooth headset with the control circuit board of the speaker base;
thereby, when an incoming call is received, the controller obtains an incoming call signal from the Bluetooth headset, and sends the incoming call signal to the amplifier and the microphone to transmit the voice signal in two-directions.
